(19) United States
(12) Patent Application Publication
(10) Pub. No.: US 2008/0235436 A1
(43) Pub. Date: Sep. 25, 2008

(54) STORAGE ACCESS CONTROL

(76) Inventors: Vincent J. Zimmer, Federal Way, WA (US); Michael A. Rothman, Puyallup, WA (US); Isaac W. Oram, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/690,353

(22) Filed: Mar. 23, 2007

(51) Int. Cl. G06F 12/00

(52) U.S. Cl. 711/103

(57) ABSTRACT

A system and device are disclosed. In one embodiment, the system includes a processor, system memory, chipset, flash memory, and flash memory controller. The flash memory controller includes a base address register for a flash memory hidden protected area (HPA) to store a flash memory HPA base address, a size register for a flash memory HPA to store a size of the flash memory HPA, and control logic to allocate a portion of the flash memory as a flash memory HPA using the flash memory HPA base address and the flash memory HPA size address.

### FIELD OF THE INVENTION

The invention relates to flash memory. More specifically, the invention relates to limiting access to portions of a flash memory.

### BACKGROUND OF THE INVENTION

Remediation operating systems and other code are helpful to increase the robustness of computer systems. Remediation code is utilized to boot a computer system safely when the normal boot process becomes corrupt. In certain scenarios, the boot process can become corrupt when unsafe or unverified code is loaded during the operating system load process. For example, a virus can load corrupt code modules to damage the system. Another way in which the normal boot process becomes corrupt is due to a damaged hard disk drive that stores the operating system. Certain sectors in a hard drive may become unreadable and thus, portions of the operating system are not able to load correctly.

Many hard drives have a hidden protected area (HPA) that stores the remediation code. The HPA in the hard drive is a portion of the hard drive that is available to use, but remains outside of the hard drive address range available to the operating system. An integrated drive electronics (IDE) hard drive controller normally has registers that contain data that can be queried using advanced technology attachment (ATA) commands. The data returned gives information about the drive attached to the controller.

Certain ATA commands are utilized in creating and utilizing a Hidden Protected Area. The commands are: IDENTIFY DEVICE, SET MAX ADDRESS, and READ NATIVE MAX ADDRESS. Operating systems use the IDENTIFY DEVICE command to find out the addressable space of a hard drive. The IDENTIFY DEVICE command queries a particular register on the IDE controller to establish the size of a drive. This register however can be changed using the SET MAX ADDRESS command. If the value in the register is set to less than the actual hard drive size then effectively a Host Protected Area is created. It is protected because the OS will only work with the value in the register that is returned by the IDENTIFY DEVICE command and thus will never be able to address the parts of the drive that lie within the HPA.

The hard drive HPA is only useful if other software and or firmware (e.g. BIOS) is able to utilize it. Software and or firmware that are able to utilize the HPA are referred to as ‘HPA aware’. The ATA command that these entities use is called READ NATIVE MAX ADDRESS. This command accesses a register that contains the true size of the hard drive. To use the area the controlling HPA aware program changes the value of the register read by IDENTIFY DEVICE with that found in the register read by READ NATIVE MAX ADDRESS, when its operations are complete the register read by IDENTIFY DEVICE is returned to its original value.

### BRIEF DESCRIPTION OF THE DRAWINGS

The present invention is illustrated by way of example and is not limited by the figures of the accompanying drawings, in which like references indicate similar elements, and in which:

FIG. 1 is a block diagram of one embodiment of a computer system and device for storage access control to a flash memory.

FIG. 2 is a flow diagram of one embodiment of a process to allocate a hidden protected area in a flash memory.

FIG. 3 is a flow diagram of one embodiment of a process to verify code is safe during the initialization of a platform and to take remediation measures if any code is unsafe.

### DETAILED DESCRIPTION OF THE INVENTION

Embodiments of a system and device for storage access control to a flash memory are described. In the following description, numerous specific details are set forth. In other instances, well-known elements, specifications, and protocols have not been discussed in detail in order to avoid obscuring the present invention.

References to “one embodiment”, “an embodiment”, “example embodiment”, “various embodiments”, “some embodiments”, “many embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

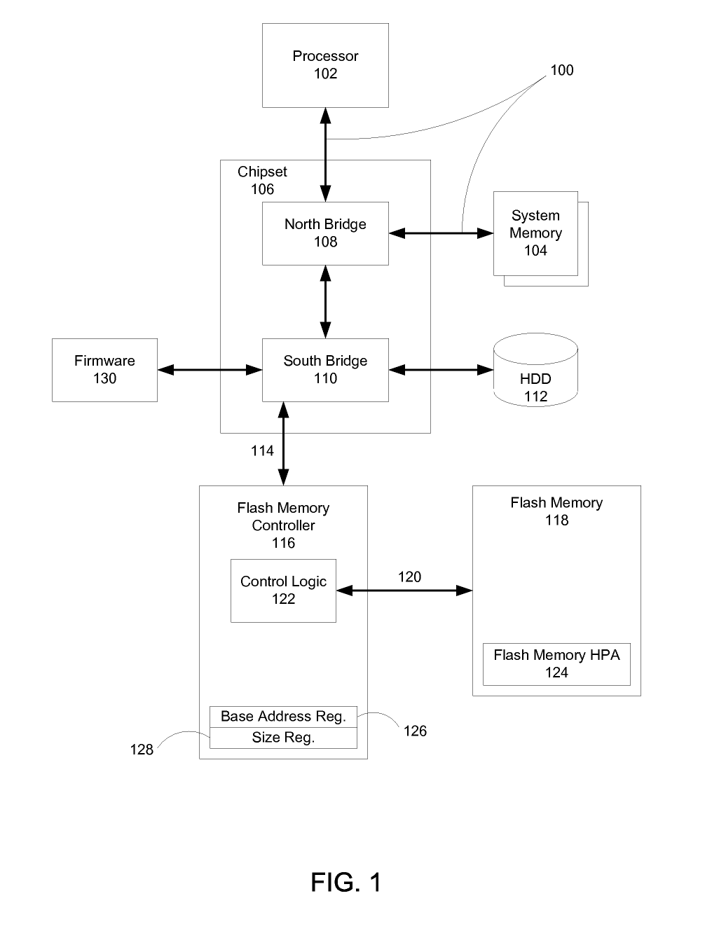

FIG. 1 is a block diagram of one embodiment of a computer system and device for storage access control to a flash memory. The computer system comprises a processor-memory interconnect 100 for communication between different agents coupled to interconnect 100, such as processors, bridges, memory devices, etc. Processor-memory interconnect 100 includes specific interconnect lines that send arbitration, address, data, and control information (not shown). In one embodiment, central processor 102 is coupled to processor-memory interconnect 100. In another embodiment, there are multiple central processors coupled to processor-memory interconnect 100 (multiple processors are not shown in this figure).

Processor-memory interconnect 100 provides the central processor 102 and other devices access to the system memory 104. A system memory controller controls access to the system memory 104. In one embodiment, the system memory controller is located within the north bridge 108 of a chipset 106 that is coupled to processor-memory interconnect 100. In another embodiment, a system memory controller is located on the same chip as central processor 102. Information, instructions, and other data may be stored in system memory 104 for use by central processor 102 as well as many other potential devices.

The chipset 106 also includes a south bridge 110 coupled to north bridge 108 through an interconnect 112. In many embodiments, interconnect 112 is a hub-link interconnect. I/O devices are coupled to the south bridge 110 of the chipset 106 through one or more I/O interconnects. For example, in many embodiments, hard disk drive (HDD) 114 is coupled to the south bridge 110 through a serial advanced technology attachment (SATA) interconnect 116. Additionally, in many embodiments, firmware 134 is coupled to the south bridge 110. In many embodiments, firmware 134 comprises a basic input output system (BIOS) that includes instructions the processor loads at boot time.

In many embodiments, the system also includes one or more PCI Express (PCIe) point-to-point interconnects, such as interconnect 118. PCIe interconnect 118 couples the south bridge 110 to a flash memory controller 120, which, in turn, is coupled to a flash memory 122 through flash memory interconnect 124 in many embodiments. In many embodiments, flash memory 122 comprises a NAND flash memory array. In some embodiments, the flash memory controller 120 comprises an Intel® Robson Technology flash memory controller.

Flash memory controller 120 provides access to the flash memory 122 to the rest of the system in FIG. 1. When the system boots, control code within an option read only memory (OROM) in the flash memory controller 120 manages the flash memory 122. The OROM is not pictured.

During the boot process, flash memory is allocated and the global address range of flash memory is created. In many embodiments, a flash memory hidden protected area (HPA) 126 is created within the flash memory 122. The flash memory HPA 126 is an address range of storage locations within the flash memory 122 that is not accessible to an operating system or virtual machine manager residing in system memory during normal system operations. Additionally, in some embodiments, the flash memory HPA 126 is not accessible by any post-BIOS control code.

In many embodiments, the flash memory controller 120 has control logic 128 that allocates the flash memory HPA 126 during system boot. In some embodiments, the flash memory controller includes a HPA base address register 130 and a HPA size register 132. The HPA base address register 130 contains an address, within the flash memory 122 address range, that is the base address of the flash memory HPA 126 to be allocated. The HPA size register 132 contains the size of the flash memory HPA 126. In different embodiments, the size unit may be bytes, quad-words, cache-lines, or any other logical size unit. Thus, the control logic 128 can utilize the HPA base address register 130 and the HPA size register 132 to allocate a portion of the flash memory 122 address range as a HPA.

For example, in one embodiment, the flash memory 122 is 1 Gigabyte in size with a physical address range of 0 to 0x07FFFFFFh. For ease of explanation, this example address range is utilized because each byte stored has its own address location. In this example, the HPA base address register 130 has a value of 0x06000000h and the HPA size register 132 has a value of 0x01FFFFFFh. Thus, the HPA base address is located three quarters up the flash memory address range (768 Megabyte up the 1 Gigabyte address range from the base address) and the HPA size is the remaining one quarter of the flash memory address range (256 Megabytes in size). Thus, in this example, when flash memory 122 is being allocated at system boot, the 256 Megabyte flash memory HPA 126 is hidden from the operating system. The control logic 128 reports to the operating system that the flash memory 122 has a physical address range of 0 to 0x05FFFFFFh. In this embodiment, the operating system is unaware of the existence of one quarter of the flash memory 122 storage locations. As a result, the operating system cannot modify the 256 Megabyte flash memory HPA 126.

In another embodiment, the flash memory HPA 126 is allocated using flash memory commands mirroring the ATA commands SET MAX ADDRESS and READ NATIVE MAX ADDRESS explained in the background section. Though, in this embodiment, the flash memory HPA 126 is always stored above the SET MAX ADDRESS location. Whereas, in the previous embodiment utilizing the HPA base address and HPA size values, the flash memory HPA 126 may be stored in any location within the flash memory 122. In yet another embodiment, there are multiple HPA base address registers and multiple HPA size registers stored within the flash memory controller 120. In this embodiment, multiple HPAs can be allocated concurrently in the flash memory 122. The multiple HPA embodiment is not shown in FIG. 1.

In many embodiments, the BIOS control code stored in firmware 134 instructs the control logic 128 within the flash memory controller to allocate the flash memory HPA 126 during system boot.

Additionally, in some embodiments, after the flash memory HPA 126 has been initially allocated, a remediation operation system is stored within the flash memory HPA 126 for use if a safe boot procedure is required. In different embodiments, the remediation operating system is any operating system that can bring the system up to a functioning level. The remediation operating system may be utilized for boot purposes if the main operating system, virtual machine manager, or other critical control code has been compromised by a virus, a bad hard drive, or other possible problem sources.

In some embodiments, an enterprise information technology (EIT) boot procedure is stored in the firmware device. The EIT boot procedure verifies that code blocks loaded during the system boot are safe. Thus, the EIT boot procedure instructs the operating system, virtual machine manager, and other critical control code to be measured and verified while the system is initializing. If any of the code blocks are determined to be unsafe (i.e. corrupt), the EIT boot procedure will instruct the control logic 128 within the flash memory controller 120 to load a remediation operating system stored in the flash memory HPA 126 into system memory 104 to allow a safe boot.

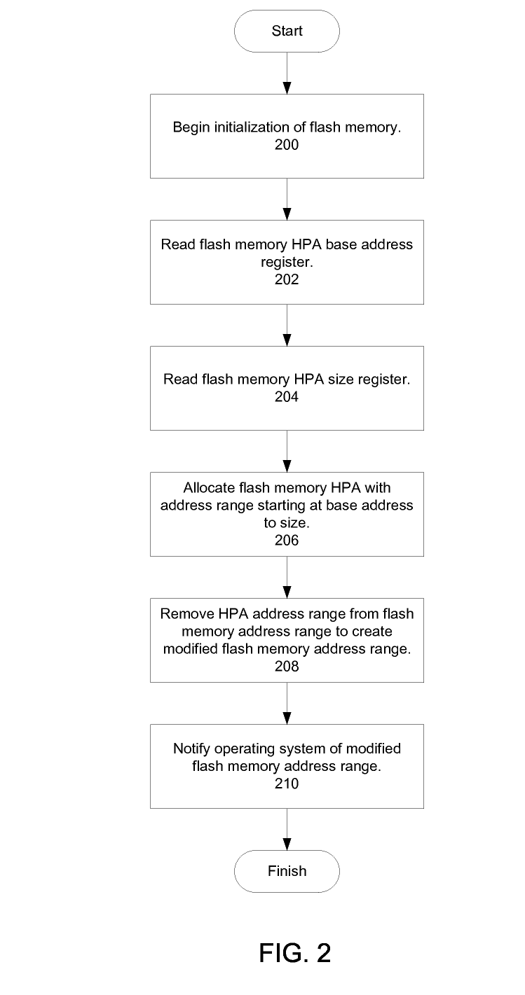

FIG. 2 is a flow diagram of one embodiment of a process to allocate a hidden protected area in a flash memory. The process is performed by processing logic that may comprise hardware (circuitry, dedicated logic, etc.), software (such as is run on a general purpose computer system or a dedicated machine), or a combination of both. Referring to FIG. 2, the process begins by processing logic beginning initialization of flash memory (processing block 200). In some embodiments, initialization includes utilizing control code within an OROM to manage the initial allocation process of the flash memory.

Next, processing logic reads the flash memory HPA base address register (processing block 202) and receives a base address value that corresponds to a location within the flash memory address range. Then, processing logic reads the flash memory HPA size register (processing block 204) and receives a size value that corresponds to the amount of flash memory that will be allocated for the HPA. In some embodiments, the flash memory HPA base address register and size register are located in a flash memory controller that controls access to the flash memory.

Processing logic then allocates the flash memory HPA with an address range starting at the HPA base address value to the flash memory address corresponding to the base address value plus the size value (processing block 206). Next, processing logic removes the HPA address range from the flash memory address range to create a modified flash memory address range (processing block 208). Finally, the operating system is notified of the modified flash memory address range (processing block 210) and the process is finished. Thus, as a result of this process, the operating system is unaware of the existence of flash memory storage locations in the HPA. As a result, the operating system cannot modify the flash memory HPA because it is outside of the logical address space where the operating system is confined.

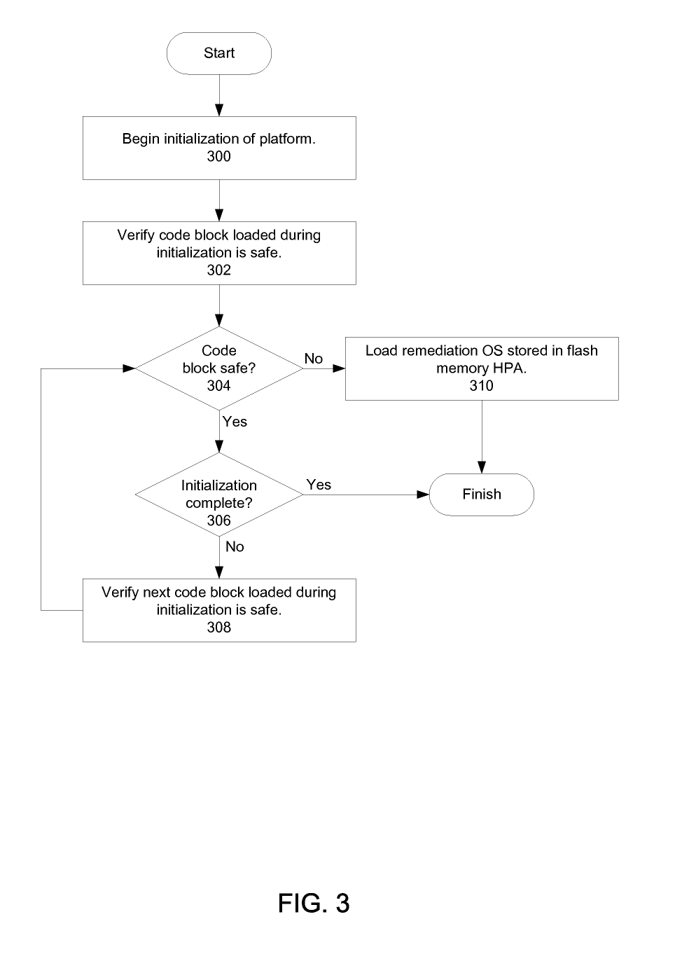

FIG. 3 is a flow diagram of one embodiment of a process to verify code is safe during the initialization of a platform and to take remediation measures if any code is unsafe. The process is performed by processing logic that may comprise hardware (circuitry, dedicated logic, etc.), software (such as is run on a general purpose computer system or a dedicated machine), or a combination of both. Referring to FIG. 3, the process begins by processing logic beginning initialization of the platform (processing block 300). In many embodiments, the platform is a computer system that has flash memory and flash memory HPA enablement logic.

The process continues with processing logic verifying that a first code block loaded during platform initialization is safe (processing block 302). In many embodiments, the operating system loads during the platform initialization through a number of code blocks brought into system memory from their storage locations on a hard drive. Many different security measures can be taken to measure and verify that operating system level code within these code blocks is safe and not corrupt. Next, processing logic determines if the first code block is safe (processing block 304).

If the code block is safe then processing logic determines if the initialization is complete (processing block 306). If the initialization is complete then the process is finished. If the initialization is not complete, then processing logic verifies that the next code block loaded during initialization is safe (processing block 308) and the process returns to processing logic determining if the next code block is safe (processing block 304).

If any code block is verified as unsafe (i.e. corrupt) for any reason, processing logic terminates loading the standard code blocks and instead loads a remediation operating system stored in the flash memory HPA (processing block 310) and the process is finished. In some embodiments, the flash memory HPA is stored in a configuration as shown in FIG. 1 and is allocated using a process as shown in FIG. 2.

Thus, embodiments of a system and device for storage access control to a flash memory are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A system, comprising:
a first interconnect;
a processor coupled to the first interconnect;
a dynamic random access memory (DRAM) coupled to the first interconnect;
a second interconnect;
a chipset coupled to the first and second interconnects;
a flash memory;
a flash memory host controller coupled to the flash memory and the second interconnect, wherein the flash memory host controller comprises
a base address register for a flash memory hidden protected area (HPA) to store a flash memory HPA base address;
a size register for a flash memory HPA to store a size of the flash memory HPA; and
logic to allocate a portion of the flash memory as a flash memory HPA, wherein the allocated portion begins at the base address location in the flash memory and extends for the size amount in the flash memory.

2. The system of claim 1, wherein the flash memory host controller is further operable to control access to the flash memory.

3. The system of claim 2, wherein the flash memory HPA is not accessible to a host operating system running on the computer system.

4. The system of claim 2, wherein the logic is further operable to store a remediation operating system in the allocated flash memory HPA.

5. The system of claim 4, further comprising a firmware device, coupled to the chipset, to store a basic input-output system (BIOS).

6. The system of claim 5, wherein the BIOS instructs the flash memory host controller to allocate the flash memory HPA during system boot.

7. The system of claim 5, further comprising an enterprise information technology (EIT) boot procedure stored in the firmware device, the EIT boot procedure to verify that code blocks loaded during system boot are safe.

8. The system of claim 7, further comprising the EIT boot procedure to instruct the logic to load the remediation operating system when one or more loaded code blocks are not safe.

9. The system of claim 1, wherein the flash memory comprises NAND flash memory.

10. A device, comprising:
a flash memory hidden protected area (HPA) base address register to store a flash memory HPA base address;
a flash memory HPA size register to store a size of the flash memory HPA; and
logic to allocate a portion of a flash memory as a flash memory HPA, wherein the allocated portion begins at the base address location in the flash memory and extends for the size amount in the flash memory.

11. The device of claim 10, wherein the device comprises a flash memory host controller, the controller further operable to control access to the flash memory.

12. The device of claim 11, wherein the logic is further operable to store a remediation operating system in the allocated flash memory HPA.

13. The device of claim 11, wherein the host controller and flash memory are located in a computer system.

14. The device of claim 13, wherein the flash memory HPA is not accessible to a host operating system running on the computer system.

15. The device of claim 10, wherein the flash memory comprises NAND flash memory.
